(19) United States
(12) Patent Application Publication
(10) Pub. No.: US 2021/0195006 A1
(43) Pub. Date: Jun. 24, 2021

(54) MOBILE TERMINAL

(71) Applicant: GUANGDONG OPPO MOBILE TELECOMMUNICATIONS CORP., LTD., Dongguan (CN)

(72) Inventor: Jie LI, Dongguan (CN)

(21) Appl. No.: 17/193,673

(22) Filed: Mar. 5, 2021

Related U.S. Application Data
(63) Continuation-in-part of application No. PCT/CN2019/095800, filed on Jul. 12, 2019.

(30) Foreign Application Priority Data
Sep. 6, 2018 (CN) 201821459213.0

(51) Int. Cl. H04M 1/02; H04N 5/225; G06F 1/16

(52) U.S. Cl. CPC H04M 1/0264; G06F 1/1686; H04N 5/225251

(57) ABSTRACT

A mobile terminal comprises a terminal device (100), an image capturing device (200) and a locking mechanism (300). A mounting recess (130) is formed at the terminal device (100). The image capturing device (200) comprises a casing (210) and a camera module (220). The locking mechanism (300) comprises a transmission member (310) and a latch bolt (320). The transmission member (210) is rotatably connected to the terminal device (100) and abuts the latch bolt (320). After the image capturing device (200) has been installed in the mounting recess (130), the latch bolt (320) is movable between a first position and a second position, and the locking mechanism (300) can lock or release the imaging capturing device (200) from the terminal device (100).

### CROSS-REFERENCE TO RELATED APPLICATIONS

This application is a continuation-in-part of International Application No. PCT/CN2019/095800 filed on Jul. 12, 2019, which claims priority to Chinese Application No. 201821459213.0 filed on Sep. 6, 2018. The entire contents of the aforementioned applications are incorporated by reference herein.

### TECHNICAL FIELD

The present disclosure relates to the field of mobile terminal technologies, and more particularly, to a mobile terminal.

### BACKGROUND

Mobile terminals (phones, tablets, etc.) are generally equipped with cameras, which are configured to provide functions such as video calling and shooting. However, shooting scenarios of the camera is relatively monotonous.

### SUMMARY

Based on the above, the disclosure provides a mobile terminal.

A mobile terminal includes a terminal device, an image capturing device and a locking mechanism.

The terminal device comprises a display screen, a first power supply module, and a first wireless communication module, wherein the first power supply module is configured to supply power to the display screen and the first wireless communication module, and the terminal device defines a mounting recess on a side thereof facing away from a display area of the display screen.

The image capturing device comprises a casing, a camera module, a second power supply module, and a second wireless communication module, wherein the second power supply module is configured to supply power to the camera module and the second wireless communication module, the camera module and the second power supply module are arranged in the casing, the camera module has a light incident surface exposed from the casing; the image capturing device is configured to be mounted in the mounting recess, thereby making the light incident surface be exposed on the side facing away from the display area; the casing is provided with an engaging slot.

The locking mechanism comprises a transmission member and a bolt, and the transmission member is rotatably mounted on the terminal device and abuts against the bolt. The locking mechanism has a lock state and a released state, the bolt is engaged with the engaging slot and the image capturing device is locked to the terminal device when the locking mechanism is in the lock state, the bolt exits from the engaging slot and the image capturing device is detachable from the mounting recess when the locking mechanism is in the released state; wherein the second wireless communication module is communicatively connected with the first wireless communication module when the locking mechanism is in the released state.

### BRIEF DESCRIPTION OF THE DRAWINGS

In order to more clearly describe the technical solutions of the disclosure, the following briefly introduces the drawings needed to be used in the description of the embodiments. Obviously, the drawings in the following description only illustrate some embodiments of the disclosure, and other drawings can be obtained for those skilled in the art, based on these drawings without any creative work.

FIG. 1 is a perspective view of a mobile terminal, wherein an image capturing device is mounted on a terminal device according to an embodiment;

FIG. 2 is another perspective view of the mobile terminal as shown in FIG. 1;

FIG. 3 is a perspective view showing the image capturing device being disassembled from the terminal device;

FIG. 4 is a block diagram of the image capturing device and the terminal device of FIG. 1;

FIG. 5 is an exploded view of the image capturing device of the mobile terminal shown in FIG. 3;

FIG. 6 is a perspective view of the image capturing device of the mobile terminal shown in FIG. 5 without a casing;

FIG. 7 is a schematic front view showing a locking mechanism of the mobile terminal shown in FIG. 2 is at a first position;

FIG. 8 is an enlarged view of a portion A of the mobile terminal shown in FIG. 7;

FIG. 9 is a schematic view showing the locking mechanism at a second position;

FIG. 10 is a schematic diagram showing an application scene of the imaging capturing device of the mobile terminal shown in FIG. 3;

FIG. 11 is a front view of the locking mechanism of the mobile terminal shown in FIG. 6 being covered with a cover plate.

### DETAILED DESCRIPTION OF PREFERRED EMBODIMENTS

In order to facilitate the understanding of the disclosure, the following will make a more comprehensive description of the disclosure with reference to the relevant drawings. The drawings illustrate preferred embodiments of the disclosure. However, this disclosure can be implemented in many different manners and is not limited to the following described embodiments. On the contrary, the purpose of providing these embodiments is to make the understanding of the disclosure more thorough and comprehensive.

The wording “terminal device” refers to, but is not limited to, a device capable of receiving and/or sending communication signals via one or more of the following communicating ways:

(1) via wired lines, such as Public Switched Telephone Networks (PSTN), Digital Subscriber Lines (DSL), digital cables, and direct cable connections;

(2) via a wireless interface, such as a cellular network, a Wireless Local Area Network (WLAN), a digital TV network (e.g., DVB-H network), a satellite network, a AM-FM broadcast transmitter.

A terminal device, which is configured to communicate through a wireless interface, may be referred to as a “mobile terminal”. Examples of the mobile terminal include but are not limited to the following electronic devices:

(1) a satellite phone or a cellular phone;

(2) Personal Communications System (PCS) terminals, capable of integrating cellular radio telephones, data processing and fax, and data communicating capabilities;

(3) a radio telephone, a pager, an Internet/Intranet access, a Web browser, a notebook, a calendar, a personal digital assistants (PDA) equipped with a Global Positioning System (GPS) receiver;

(4) a conventional laptop and/or palmtop receiver;

(5) a conventional laptop and/or palmtop radio telephone transceiver; etc.

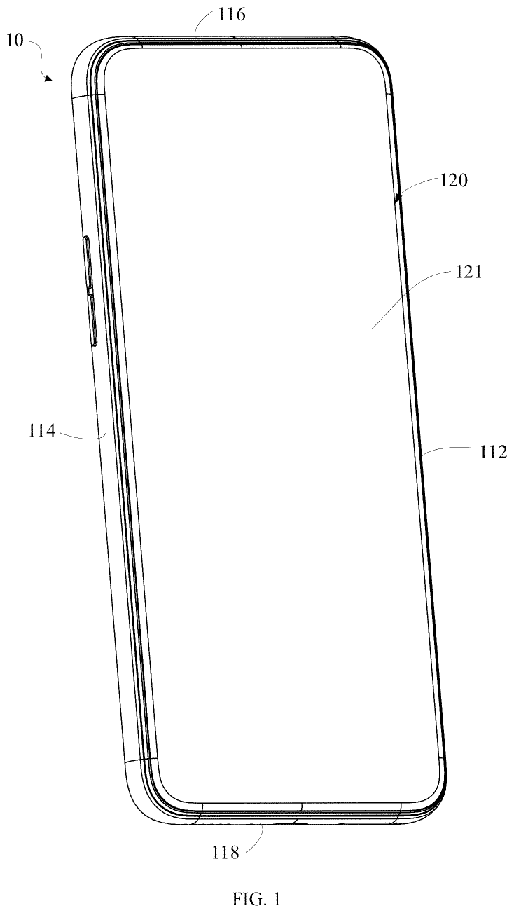

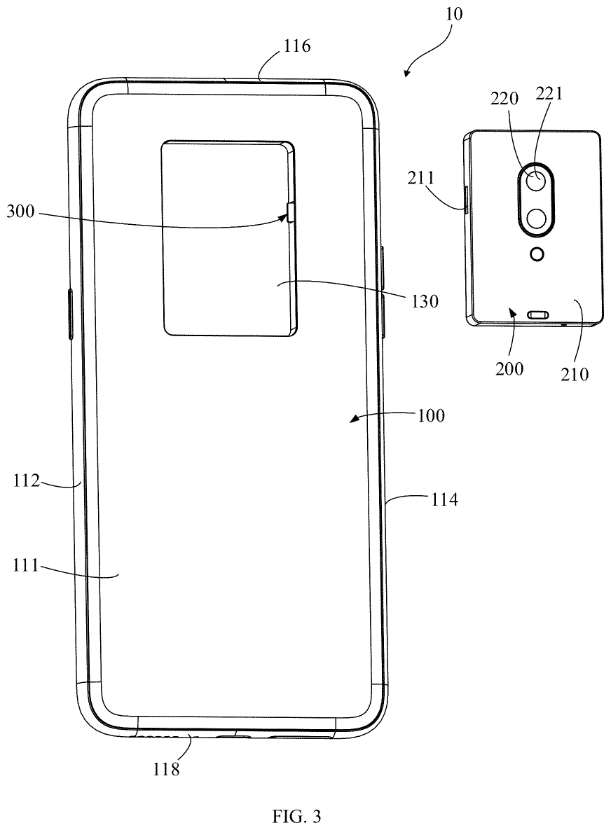

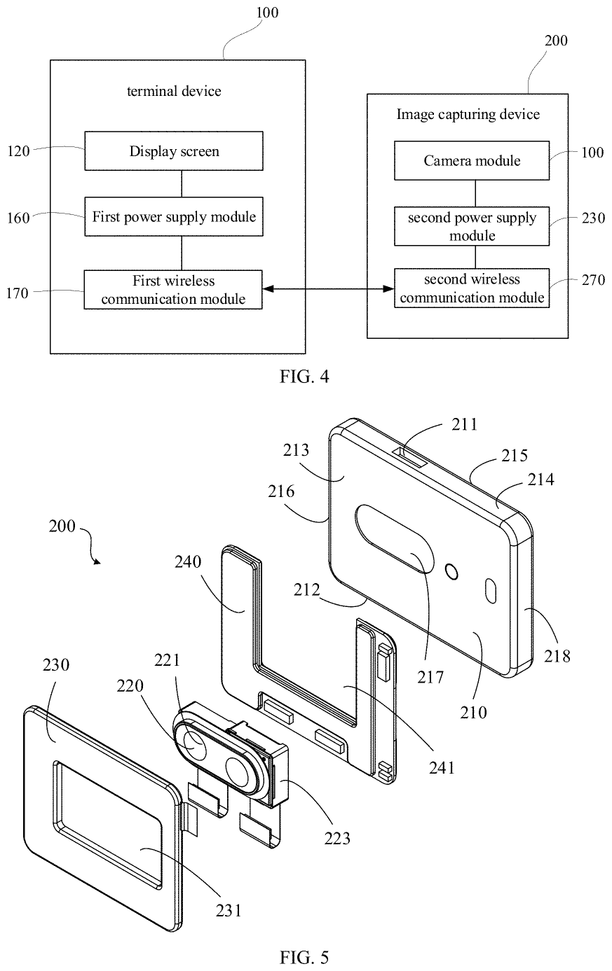

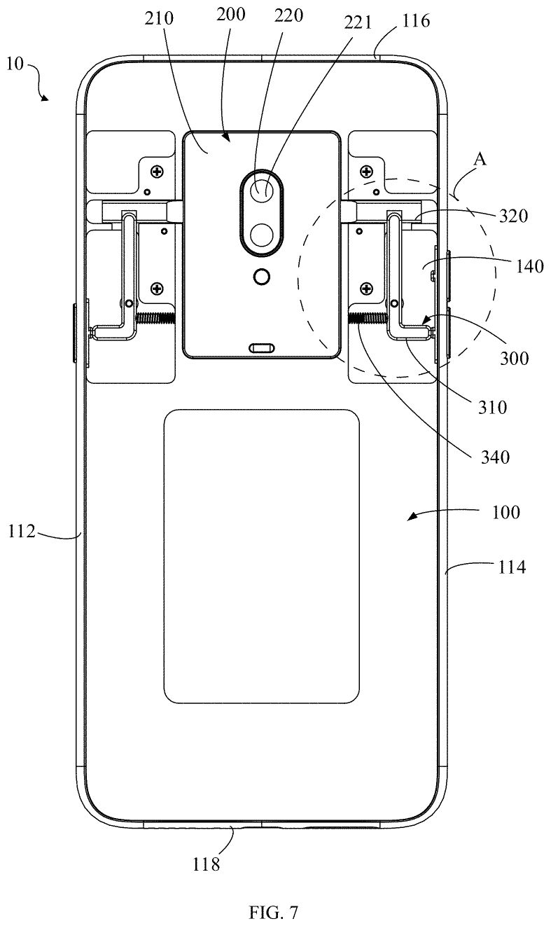

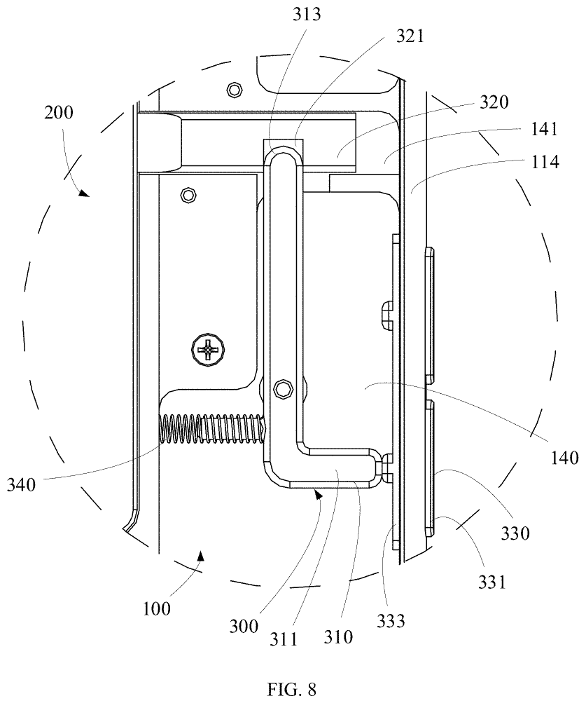

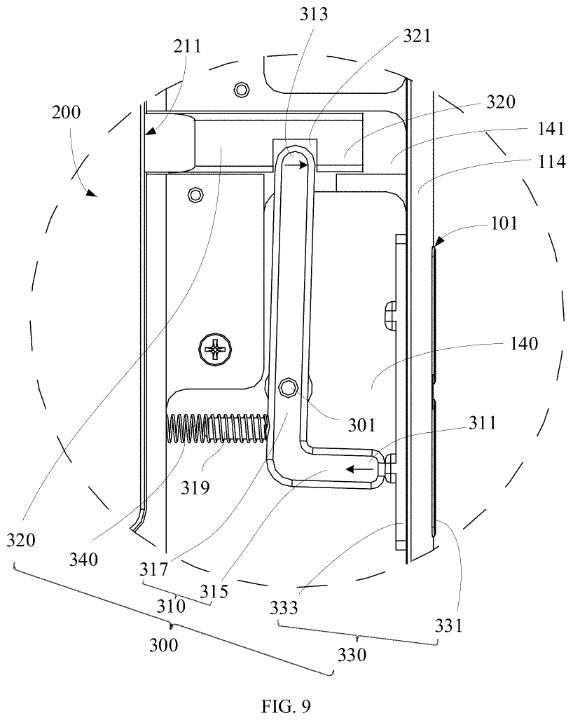

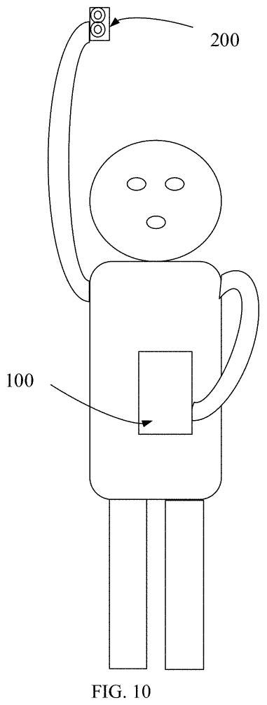

In the embodiment as illustrated in FIG. 1 to FIG. 4, a mobile terminal 10 is a smart phone. The mobile terminal 10 includes a terminal device 100, an image capturing device 200 and a locking mechanism 300. The terminal device 100 includes a display screen 120, a first power supply module 160, and a first wireless communication module 170. The first power supply module 160 is configured to supply power to the display screen 120 and the first wireless communication module 170. The first display screen 120 is configured to display information and provide an interactive interface for a user. The terminal device 100 defines a mounting recess 130 at one side which is facing away a display area 121 of the display screen 120. As illustrated in FIG. 4 to FIG. 6, the image capturing device 200 includes a casing 210, a camera module 220, a second power supply module 230, and a second wireless communication module 270. The second power supply module 230 is configured supply power to the camera module 220 and the second wireless communication module 270. The camera module 220 and the second power supply module 230 are arranged in the casing 210. The camera module 220 has a light incident surface 221, which is exposed from the casing 210. Ambient lights can pass through the light incident surface 221 and enter into a photosensitive element of the camera module 220. The image capturing device 200 can be installed in the mounting recess 130, thereby enabling the light incident surface 221 to be exposed on the side facing away from the display area 121 of the display screen 120. The casing 210 is provided with an engaging slot 211. Referring to FIG. 7 to FIG. 9, the locking mechanism 300 includes a transmission member 310 and a bolt 320, and the transmission member 310 is rotatably connected to the terminal device 100 and abuts against the bolt 320. The transmission member 310 is capable of rotating relative to the terminal device 100, the bolt 320 is capable of selectively moving to a first position and/or a second position, and the locking mechanism 300 accordingly has a lock state and/or a released state. Referring to FIG. 8, at the first position, the bolt 320 is engaged with the engaging slot 211 and the image capturing device 200 is locked to the terminal device 100. At the second position as illustrated in FIG. 9, the bolt 320 exits from the engaging slot 211 and the image capturing device 200 is capable of being detached/disassembled from the mounting recess 130. When the image capturing device 200 is capable of being detached/disassembled from the mounting recess 130, the second wireless communication module 270 is still communicatively connected with the first wireless communication module 170, thereby achieving the communication between the image capturing device 200 and the terminal device 100.

The first wireless communication module 170 and the second communication module 270 are configured for data transmission between the terminal device 100 and the image capturing device 200. The first wireless communication module 170 and the second wireless communication module 270 may utilize Near Field Communication technology, and the first wireless communication module 170 and the second wireless communication module 270 use the same communication protocol. For example, the first wireless communication module 170 and the second wireless communication module 270 both may be Bluetooth communication modules, or both may be Wireless Fidelity (Wi-Fi) communication modules, or both may be Infrared Data (IrDA) communication modules, or both may be ZigBee communication modules, or both may be Ultra WideBand, or both may be Near Field Communication (NFC) modules, etc. In an alternative embodiment, the terminal device 100 may include a third wireless communication module, which is configured to communicate with an external device such as a base station or another mobile terminal 10, thereby facilitating communication between more than one mobile terminals 10.

When the image capturing device 200 is locked in the mounting recess 130, the image capturing device 200 may communicate with the first wireless communication module 170 by the second wireless communication module 270, and the camera module 220 at this time can perform functions as a rear camera. A user can perform remote shooting, video recording and other operations through the image capturing device 200. When the image capturing device 200 is detached from the mounting recess 130, the second wireless communication module 270 can still communicate with the first wireless communication module 170, and the user at this time can use the image capturing device 200 to shoot with any direction in any scene.

In the above mobile terminal 10, the image capturing device 200 not only can be installed in the mounting recess 130 but also can be released from the mounting recess 130. After the image capturing device 200 is taken out from the mounting recess 130, the image capturing device 200 communicates with the first wireless communication module 170 of the terminal device 100 through the second wireless communication module 270, and the user can use the image capturing device 200 to shoot in multiple directions and multiple scenarios. In the embodiment as illustrated in FIG. 9, the user can hold the image capturing device 200 with one hand and the terminal device 100 with the other hand, so the user can capture images at various positions and directions through the image capturing device 200, and view the images through the display screen 120 of the terminal device 100. In an alternative embodiment, the user may dispose the image capturing device 200 in a certain place, and view the images captured by the image capturing device 200 through the terminal device 100 in another place. Since the image capturing device 200 can be taken out from the terminal device 100 and maintain in communication with the terminal device 100 after being taken out, the terminal device 100 does not need to provide a front camera on the side that the display screen 120 locates, so the screen-to-body ratio of the terminal device 100 can be increased. For example, the screen-to-body ratio of the terminal device 100 with the above structure may be more than 85%. It can be understood that, the arrangement of the locking mechanism 300 can reliably fix the image capturing device 200 in the mounting recess 130 and can prevent the image capturing device 200 from easily falling out of the mounting recess 130. When the locking mechanism 300 releases the locking to the image capturing device 200, the image capturing device 200 can be taken out of the mounting recess 130, thereby facilitating the usage for the user.

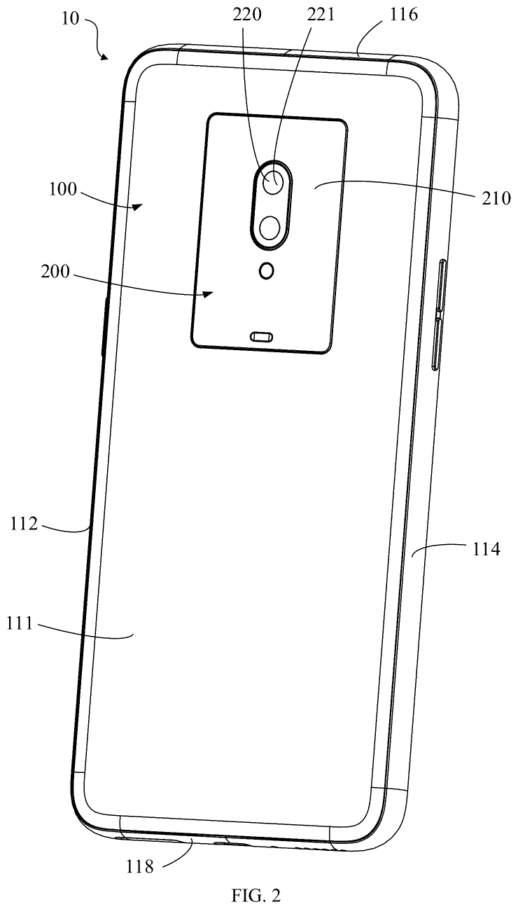

In the embodiments as illustrated in FIG. 1 and FIG. 2, the terminal device 100 is substantially in a shape of cuboid. The mobile terminal 10 includes a rear wall 111 and side walls connected to outer peripheries of the display screen 120. The rear wall 111 is located at the side facing away from the display area 121 and connected to the side walls. The side walls include a left side wall 112, a right side wall 114 opposite to the left side wall 112, a top side wall 116, and a bottom side wall 118 opposite to the top side wall 116. Each of the left side wall 112 and the right side wall 114 are located between the top side wall 116 and the bottom side wall 118. Each of the top side wall 116 and the bottom side wall 118 are located between the left side wall 112 and the right side wall 114. The mounting recess 130 penetrates through the rear side wall 111. The mounting recess 130 is located between the left side wall 112 and the right side wall 114, and also is located between the top side wall 116 and the bottom side wall 118. In one embodiment, the mobile terminal 10 is provided with two locking mechanisms 300, one is located adjacent to the left side wall 112, and the other is located adjacent to the right side wall 114. In the following, the locking mechanism 300 located adjacent to the right side wall 114 is taken as an example for description. However, it can be understood that there may be only one locking mechanism 300 included in the mobile terminal 10.

In one embodiment, the rear wall 111 and the side walls may consist a rear cover, in other words, the rear cover includes the rear wall 111 and the side walls. In another embodiment, the rear wall 111 may consist a rear cover while the side walls may consist a middle frame of the terminal device 10, in other words, the terminal device 100 may include a rear cover consisting the rear wall and a middle frame consisting the side walls.

The terminal device 100 may further include a middle plate 140, the middle plate 140 is positioned between the display screen 120 and the rear wall 111. The transmission member 310 is rotatably connected to the middle plate 140, and the bolt 320 is slidably coupled to the middle plate 140. The middle plate 140 can be integrally formed with the side walls, or can be detachably connected with the side walls. Using the middle plate 140 to support the bolt 320 and the transmission member 310 can improve the structural stability of the locking mechanism 300.

The locking mechanism 300 includes a pressing block 330, which includes a block body 331 and a limit part 333 integrally formed with the block body 331. One of the side walls is provided with an installation hole 101, the block body 331 engages with the installation hole 101. The limit part 333 is positioned between the side wall and the transmission member 310, and the side wall and the transmission member 310 can abut the limit part 333 respectively. The pressing block 330 can press the transmission member 310 thereby enabling the transmission member 310 to be rotatable relative to the middle plate 140. In one embodiment, the user presses the pressing block 330, the pressing block 330 presses the transmission member 310, and the transmission member 310 rotates relative to the middle plate 140, so that the bolt 320 can be driven to slide relative to the middle plate 140, meanwhile the bolt 320 is enabled to be capable of being exited from the engaging slot 211. It can be understood that the pressing block 330 is not necessary in the disclosure. As an exemplary alternative embodiment, the transmission member 310 may protrude out and be exposed from the installation hole 101, so the bolt 320 can also be exited from the engaging slot 211 when the user pressing a protruding portion of the transmission member 310. The pressing block 330 may be a press button in some embodiments.

In one embodiment, the locking mechanism 300 further includes an elastic member 340. One end of the elastic member 340 abuts against the middle plate 140, and the other end of the elastic member 340 abuts against the transmission member 310. The elastic member 340 can press the limit part 333 via the transmission member 310, thereby making the limit part 333 abut against one side wall and the block body 331 protrude from an outer surface of said side wall. Disposing the elastic member 340 can facilitate the return of the pressing block 330 and the bolt 320, so the bolt 320 can be inserted into or exited from the mounting recess 130, the outer surface of the block body 331 can be protruded from the sidewall to facilitate the user to press the pressing block 330, and thereby facilitating the detachment of the image capturing device 200 from the mounting recess 130. The elastic member 340 may be a spring, an elastic piece, an elastic column, or the like. The elastic member 340 can be compressed under the pressing of the transmission member 310. When the pressing block 330 is released, the elastic member 340 can push the pressing block 330 back. It can be understood that the elastic member 340 is not necessary in the disclosure, as in an exemplary alternative embodiment, a structure such as a pull rod may be provided to push the transmission member 310 back into position.

As illustrated in FIG. 8, the bolt 320 is provided with a notch 321. The transmission member 310 includes a first end 311 and a second end 313. The first end 311 abuts against the limit part 333, and the second end 313 is received in the notch 321 and rotatable relative to the bolt 320. Specifically, a cross-section of the second end 313 is arc-shaped, and the second end 313 may be substantially spherical. During the rotation of the transmission member 310 relative to the middle plate 140, the second end 313 is received in the notch 321 and can rotate relative to the bolt 320, thereby avoiding interference with the sliding of the bolt 320. Such a structure facilitates the assembly of the transmission member 310 and the bolt 320. It can be understood that the transmission member 310 can also be rotatably connected with the bolt 320 in an engagement form of a rotating shaft with a shaft hole, which will not be detailed here.

As illustrated in FIG. 8 and FIG. 9, the transmission member 310 is rotatably mounted on the middle plate 140 through a rotating pivot 301. Specifically, the transmission member 310 includes a first shaft portion 315 and a second shaft portion 317, the second shaft portion 317 is connected to and substantially perpendicular to the first shaft portion 315. The second shaft portion 317 is pivotally mounted on the middle plate 140 through the rotating pivot 301. The first end 311 is positioned on the first shaft portion 315 and is away from the second shaft portion 317. The second end 313 is positioned on the second shaft portion 317 and is away from the first shaft portion 315.

The transmission member 310 may further include a supporting column 319, which extends from the second shaft portion 317 and is adjacent to the image capturing device 200. In other words, the first shaft portion 315 and the supporting column 319 both extend from the second shaft portion 317 towards opposite directions, the first shaft portion 315 extends toward the side wall, and the supporting column 319 extends toward the image capturing device 200. A portion of the elastic member 340 is sleeved on the supporting column 319, and the elastic member 340 is positioned between the second shaft portion 317 and an edge of the middle plate 140.

The locking mechanism 300 has a first state and a second state, in other words, the lock state and the released state. In the first state as illustrated in FIG. 8, the second shaft portion 317 is substantially parallel to a length direction of the terminal device 100, the bolt 320 is inserted into the engaging slot 211 of the image capturing device 200, that is, the image capturing device 200 is locked to the terminal device 100. In the second state, the pressing block 330 being pressed, the limit part 333 pushes the first end 311 to move closer to the image capturing device 200, so the transmission member 310 is pushed to slightly rotate in a clockwise direction as illustrated in FIG. 9, then the second end 313 is driven to move away from the image capturing device 200, and the bolt 320 is driven by the second end 313 to move away from the image capturing device 200, finally the bolt 320 is exited from the engaging slot 211 and the image capturing device 200 is then released from the terminal device 100, as illustrated in FIG. 9.

Correspondingly, the transmission member 310 also has an original position and a final position, the original position corresponds to the lock state, and the final position corresponds to the released state. The elastic member 340 also has an original state and a final state, the original state corresponds to the lock state, and the final state corresponds to the released state. In the original state, the elastic member 340 may be in a free state or may be compressed in a slightly compressed state. In the final state, the elastic member 340 is compressed to be in a compressed state or in a further compressed state. That is, a compressed deformation of the elastic member in the final state is greater than that of the elastic member in the original state.

It is noted that, a moving direction of the first end 311 is opposite to that of the second end 313. When the user presses the block body 331, the pressing block 330 and the first end 311 substantially move along a first direction, which is closer to the image capturing device 200, meanwhile the bolt 320 and the second end 312 substantially move along a second direction, which is away from the image capturing device 200, as illustrated in FIG. 9.

In particular, when the image capturing device 200 has been installed in the mounting recess 130 and it is required to be disassembled from the terminal device 100, the user may press the pressing block 330, thereby enabling the locking mechanism 300 to switch from the lock state to the released state. Specifically, when the user wants to disassemble the image capturing device 200 from the terminal device 100, the user can press the block body 331, then the limit part 333 presses the first end 311 of the transmission member 310, the elastic member 340 is compressed and the transmission member 310 pivotally rotates relative to the middle plate 140 in a clockwise direction, then the second end 312 of the transmission member 310 moves in a direction opposite to that of the first end 311, thereby driving the bolt 320 to move in a direction away from the image capturing device 200 and the mounting recess 130. As such, the bolt 320 moves until it exits from the engaging slot 211, which makes the locking mechanism 300 be in the released state. The user can take up the image capturing device 200 from the terminal device 100 under the released state.

It is noted that, if the user releases the pressing block 330, the locking mechanism 300 will be restored to the lock state. That is, when the pressing block 330 is pressed, the locking mechanism 300 switches to the released state, and when the pressing block 330 is released, the locking mechanism 300 switches to the lock state.

Correspondingly, when the image capturing device 200 is needed to be mounted in the mounting recess 130 or the user wants to install the image capturing device 200 onto the terminal device 100, the user can press the pressing block 330 again, the locking mechanism 300 switches to the released state, then the image capturing device 200 can be mounted in the mounting recess 130. After the image capturing device 200 has been successfully mounted in the mounting recess 130, the user can release the pressing block 330, so the locking mechanism 300 switches to the lock state and locks the image capturing device 200 to the terminal device 100.

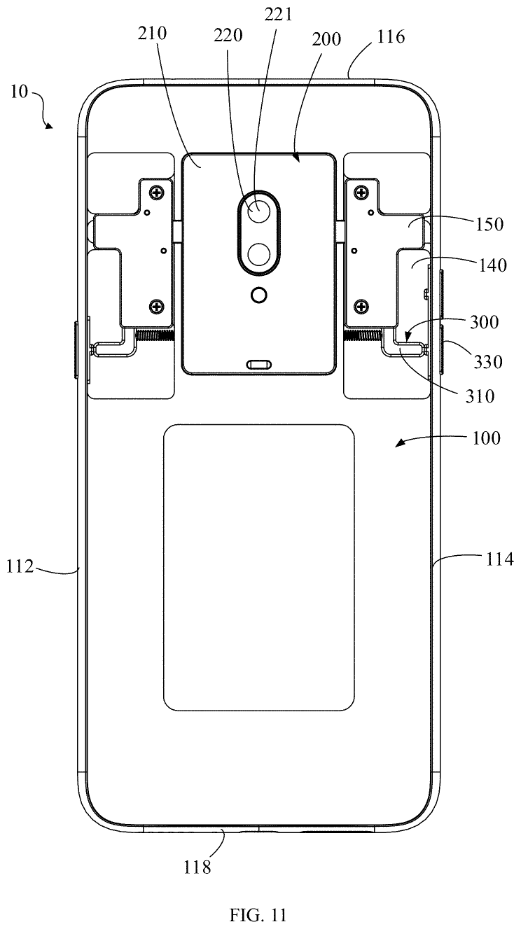

In one embodiment as illustrated in FIG. 8, the middle plate 140 is provided with a sliding groove 141, and the bolt 320 is engaged with and partially provided in the sliding groove 141. Referring to FIG. 11, the terminal device 100 further includes a cover plate 150 detachably coupled to the middle plate 140, and the cover plate 150 covers the sliding groove 141. The bolt 320 slides in the sliding groove 141, the sliding groove 141 and the cover plate 150 can guide and limit the sliding of the bolt 320, which is beneficial to a smooth movement of the bolt 320. Such a structure also facilitates the assembly and disassembly of the cover plate 150 and the middle plate 140.

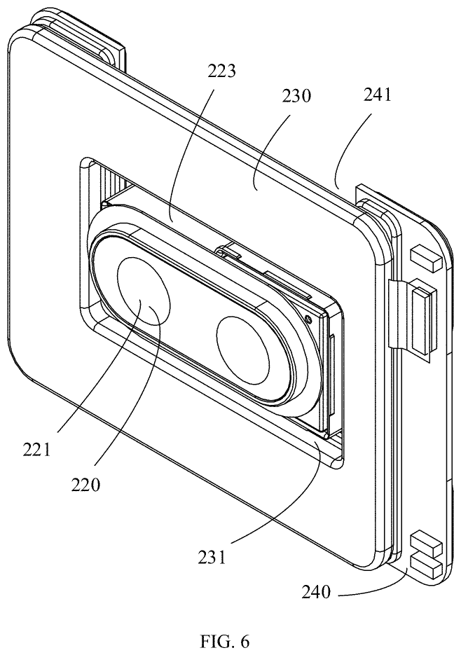

Referring to FIG. 5 and FIG. 6, the image capturing device 200 is substantially in a shape of a cuboid. The casing 210 includes a front end surface 213, a rear end surface 215 opposite to the front end surface 213, and side end surfaces connected between the front end surface 213 and the rear end surface 215. The side end surfaces include a left end surface 212, a right end surface 214 opposite to the left end surface 212, a top end surface 216, and a bottom end surface 218 opposite to the top end surface 216. Each of the left end surface 212 and the right end surface 214 is located between the top end surface 216 and the bottom end surface 218, and each of the top end surface 216 and the bottom end surface 218 is located between the left end surface 212 and the right end surface 214. The light incident surface 221 is exposed on the front end surface 213, and the engaging slot 211 is provided in the left end surface 212 and the right end surface 214. For example, the engaging slot 211 may be a through slot penetrating through the left end surface 212 and the right end surface 214. For another example, the image capturing device 200 may defines two engaging slots 211 respectively exposed from the left end surface 212 and the right end surface 214, that is, the two engaging slots 211 each are blind slots. When the mobile terminal 10 includes two locking mechanisms 300, the bolt 320 of one locking mechanism 300 engages with one engaging slot 211 of the image capturing device 200, while the bolt 320 of the other locking mechanism 300 engages with the other engaging slot 211 of the image capturing device 200. When the image capturing device 200 is mounted in the mounting recess 130, the front end surface 213 can be flush with an outer surface of the rear wall 111. Thus, after the image capturing device 200 with such a structure is installed in the mounting recess 130, the mobile terminal 10 can maintain a high overall appearance consistency. In one embodiment, the light incident surface 221 protrudes from the front end surface 213. With such a structure, the portion that the light incident surface 221 of the image capturing device 200 is located, can have a relatively thicker thickness, while other portions of the image capturing device 200 can be made relatively thinner. Therefore, it is beneficial to the lightness and thinness of the image capturing device 200, which in turn is beneficial to the lightness and thinness of the mobile terminal 10.

As one embodiment, the image capturing device 200 may include one or more module contacts, and the terminal device 100 includes one or more device contacts. When the image capturing device 200 is installed in the mounting recess 130, the module contacts can be in contact with the device contacts respectively, so that the terminal device 100 can charge the image capturing device 200. Such a structure facilitates the terminal device 100 to charge the image capturing device 200 and is beneficial for the image capturing device 200 to retain sufficient power for the convenience of the user. It is understood that the module contacts and/or the device contacts may be metal contacts, and the module contacts and the device contacts may have various structural forms. For example, the image capturing device 200 may define small holes and metal contacts can be respectively installed therein as the module contacts, the terminal device 100 can be provided with protruding metal contacts as the device contacts, thereby realizing the charging of the terminal device 100 to the image capturing device 200 through the cooperation of the module contacts and the device contacts.

Referring to FIG. 5 and FIG. 6, a module main board 240 is provided in the casing 210. The front end surface 213 of the casing 210 is provided with a light exit hole 217, and the light incident surface 221 is exposed from the light exit hole 217. The second power supply module 230 is stacked on the module main board 240 and can supply power to the module main board 240. The module main board 240 can respectively communicate with the camera module 220 and the second wireless communication module 270. The module main board 240 may include a circuit board and a number of electronic components connected to the circuit board. The module main board 240 is configured to process image information captured by the camera module 220 and send it to the terminal device 100 through the second wireless communication module 270. The module main board 240 is substantially U-shaped and defines a gap 241 thereby. The camera module 220 includes a lens barrel 223, and the lens barrel 223 penetrates the gap 241. Such a design can avoid stacking the lens barrel 223 on the module main board 240, thereby making internal components in the image capturing device 200 be more compact arrange, it is beneficial to reduce a thickness of the image capturing device 200.

Furthermore, the second power supply module 230 is provided with a through hole 231, so the second power supply module 230 is substantially annular. The through hole 231 communicates with the gap 241, and the lens barrel 223 penetrates the through hole 231 and the gap 241 thereby receiving in the through hole 231 and the gap 241. Such a structure can avoid stacking the lens barrel 223 on the second power supply module 230, thus making the arrangement of internal components in the image capturing device 200 be more compact, and reducing the thickness of the image capturing device 200. It can be understood that the first power module and the second power supply module 230 each include a battery that can be repeatedly charged and discharged, such as a lithium battery. In other embodiments, the first power module and the second power supply module 230 each may also be a fuel cell or other batteries, and the second power supply module 230 may be connected to the module main board 240 through a power flexible printed circuit board, thereby enabling the second power supply module 230 supply power to the module main board 240, and details are not repeated here.

Technical features of the above-mentioned embodiments can be combined arbitrarily. In order to make the description concise, all possible combinations of the various technical features in the above-mentioned embodiments are not described. However, as long as there is no contradiction in the combination of these technical features, any combination should be considered as the scope of this specification.

The above-mentioned embodiments only describe several embodiments of the disclosure, and the description is relatively specific and detailed, but it should not be understood as a limitation on the scope of the disclosure. It should be pointed out that for those of ordinary skill in the art, modifications and improvements can be made without departing from the concept of this disclosure, and these should fall within the protection scope of this disclosure. Therefore, the scope of protection of this disclosure shall be subject to the appended claims.

What is claimed is:

1. A mobile terminal, comprising:
a terminal device, comprising a display screen, a first power supply module, and a first wireless communication module, wherein the first power supply module is configured to supply power to the display screen and the first wireless communication module, and the terminal device defines a mounting recess facing away from a display area of the display screen;
an image capturing device, comprising a casing, a camera module, a second power supply module, and a second wireless communication module, wherein the second power supply module is configured to supply power to the camera module and the second wireless communication module, the camera module and the second power supply module are disposed in the casing, and the casing is provided with an engaging slot; and
a locking mechanism, comprising a transmission member and a bolt, wherein the transmission member is rotatably mounted on the terminal device and abuts against the bolt;
wherein the locking mechanism has a lock state and a released state, the bolt is engaged with the engaging slot and the image capturing device is locked to the terminal device when the locking mechanism is in the lock state, the bolt exits from the engaging slot and the image capturing device is detachable from the mounting recess when the locking mechanism is in the released state;
wherein the second wireless communication module is communicatively connected with the first wireless communication module when the locking mechanism is in the released state.

2. The mobile terminal according to claim 1, wherein the terminal device comprises a middle plate and a rear wall, the middle plate is positioned between the display screen and the rear wall, the rear wall is opposite to the display area of the display screen, the mounting recess is exposed from the rear wall, and the transmission member is pivotally mounted on the middle plate.

3. The mobile terminal according to claim 2, wherein the locking mechanism comprises a pressing block, the terminal device further comprises a side wall connected between the rear wall and the display screen, the side wall is provided with an installation hole, and the pressing block is movably engaged with the installation hole.

4. The mobile terminal according to claim 3, wherein the pressing block comprises a block body and a limit part integrally with the block body, the block body is exposed from the installation hole; the limit part is positioned between the transmission member and the side wall.

5. The mobile terminal according to claim 4, wherein the locking mechanism comprises an elastic member, one end of the elastic member abuts against the middle plate, and another end of the elastic member abuts against the transmission member.

6. The mobile terminal according to claim 5, wherein the elastic member has an original state and a final state, the original state of the elastic member corresponds to the lock state, the final state of the elastic member corresponds to the released state, a compressed deformation of the elastic member in the final state is greater than that of the elastic member in the original state.

7. The mobile terminal according to claim 5, wherein the transmission member comprises a first shaft portion, a second shaft portion, and a supporting column, the second shaft portion is perpendicular to each of the first shaft portion and the supporting column, the first shaft portion has a first end abuts against the limit part, the second shaft portion has a second end engages with the bolt, the elastic member is partially sleeved on the supporting column.

8. The mobile terminal according to claim 4, wherein the bolt is provided with a notch, the transmission member comprises a first end and a second end, the first end abuts against the limit part, and the second end engages with the notch and is rotatable relative to the bolt.

9. The mobile terminal according to claim 2, wherein the middle plate is provided with a sliding groove, and the bolt engages with the sliding groove.

10. The mobile terminal according to claim 9, wherein the terminal device comprises a cover plate, the cover plate is detachably coupled with the middle plate and covers the sliding groove.

11. The mobile terminal according to claim 1, wherein the image capturing device comprises a module main board disposed in the casing, the second power supply module is stacked on the module main board and configured to supply power for the module main board, the module main board respectively communicates with the camera module and the second wireless communication module; the module main board defines a gap, the camera module engages with the gap.

12. The mobile terminal of claim 11, wherein the second power supply module is provided with a through hole in communication with the gap, and the camera module engages with the through hole and the gap.

13. The mobile terminal of claim 1, wherein the transmission member comprises a first end and a second end, the second end engages with a notch of the bolt, and a moving direction of the first end is opposite to that of the second end.

14. A mobile terminal, comprising:
a terminal device, comprising a rear cover and a mounting recess exposed from the rear cover;
an image capturing device, comprising a casing and a camera module, wherein the camera module is disposed in the casing, the casing defining an engaging slot; and
a locking mechanism, comprising a transmission member and a bolt, wherein the transmission member is pivotally mounted on the terminal device and abuts against the bolt;
wherein the locking mechanism is switchable from a first state to a second state, the bolt is engaged with the engaging slot and the image capturing device is locked to the terminal device when the locking mechanism is in the first state, the bolt exits from the engaging slot and the image capturing device is detachable from the mounting recess when the locking mechanism is switched to the second state;
wherein the image capturing device is communicatively connected with the terminal device when the locking mechanism is in the second state.

15. The mobile terminal according to claim 14, wherein the terminal device comprises a display screen, a first power supply module and a first wireless communication module, the display screen is opposite to the rear cover, the first power supply module is configured to supply power for the display screen and the first wireless communication module, and the first wireless communication module is configured to communicate with the image capturing device.

16. The mobile terminal according to claim 14, wherein the image capturing device comprises a second power supply module and a second wireless communication module, the second power supply module is configured to supply power for the camera module and the second wireless communication module, the second power supply module is disposed in the casing; the image capturing device is communicatively coupled with the terminal device through the second wireless communication module.

17. The mobile terminal according to claim 16, wherein the image capturing device comprises a module main board disposed in the casing, the second power supply module is stacked on the module main board, the module main board respectively communicates with the camera module and the second wireless communication module; the module main board defines a gap, the camera module engages with the gap.

18. The mobile terminal of claim 17, wherein the second power supply module is provided with a through hole in communication with the gap, and the camera module engages with the through hole and the gap.

19. The mobile terminal of claim 14, wherein the transmission member is pivotally mounted on the terminal device, the transmission member comprises a first end and a second end, the second end engages with a notch of the bolt, a moving direction of the first end is opposite to that of the second end.

20. A mobile terminal, comprising:
a terminal device, comprising a display screen, a first wireless communication module, and a rear cover opposite to the display screen, wherein the rear cover comprises a rear wall and a side wall, the terminal device defines a mounting recess exposed from the rear wall and facing away from the display screen;
an image capturing device, comprising a casing, a camera module, and a second wireless communication module, wherein the second wireless communication module is in communication with the first wireless communication module, the camera module and the second wireless communication module are disposed in the casing, the casing is provided with an engaging slot; and
a locking mechanism, comprising a transmission member and a bolt, wherein the transmission member comprises a first shaft portion and a second shaft portion perpendicular to the first shaft portion, the second shaft portion is pivotally mounted on the terminal device and engages with the bolt, the first shaft portion extends toward the side wall, the locking mechanism has a lock state and a released state, the bolt is engaged with the engaging slot and the image capturing device is locked to the terminal device when the locking mechanism is in the lock state, the bolt exits from the engaging slot and the image capturing device is detachable from the mounting recess when the locking mechanism is in the released state.
